(19) United States
(12) Patent Application Publication
(10) Pub. No.: US 2015/0367345 A1
(43) Pub. Date: Dec. 24, 2015

(54) CONTINUOUS FLOW CENTRIFUGAL MICROFLUIDIC PARTICLE CONCENTRATOR, AND RELATED METHODS

(71) Applicant: Agilent Technologies, Inc., Santa Clara, CA (US)

(72) Inventors: Chong Wing Yung, Santa Clara, CA (US); Alicia Scheffer-Wong, Santa Clara, CA (US)

(21) Appl. No.: 14/310,838

(22) Filed: Jun. 20, 2014

(51) Int. Cl. B01L 3/00; B01D 21/26; G01N 15/10

(52) U.S. Cl. CPC B01L 3/502753; G01N 15/10; B01D 21/262; B01L 2400/0409; B01L 2300/0803; B01L 2300/0877; B01L 2300/087; B01L 2200/10

(57) ABSTRACT

A microfluidic disk for concentrating particles includes a plurality of distribution channels and separation channels. A sample fluid is flowed through the distribution channels while the disk is spun. Particles of the sample fluid flow into the separation channels where they accumulate. The particles in the separation channels may be subjected to an analysis.

### TECHNICAL FIELD

The present invention relates generally to the concentration or separation of particles of a selected size, particularly with the use of centrifugal force and/or inertial focusing and in a continuous fluid flow process.

### BACKGROUND

There is a need in several fields of application to separate rare and physically discrete particles from large volumes of fluids. A few examples include the separation of rare microbial cells from sea water, and circulating cancer cells from blood. Because of the rarity of such particles, it has been necessary to process a relatively large sample volume of fluid (e.g., 50 mL-1000 mL) to avoid missing these stochastically or discretely distributed particles. Filtration and centrifugation have been the traditional means of separating particles, particularly cells, from large volumes of fluid. However filters, especially dead-end types, quickly clog when processing complex biological fluids. Moreover, centrifugation often does not work well, particularly with neutrally buoyant marine microbes in sea water. Cells retained by either method may also be damaged by large pressure differentials or permanently embedded within the filtration surface and irretrievable for further processing. Microfluidic cell separation technologies are a promising alternative to these methods, but are not designed for continuous processing nor work well with complex biological fluids that easily clog the small dimensions of microfluidic channels.

In view of the foregoing, there is a need for devices and methods for concentrating or separating particles that avoid the limitations associated with conventional devices and methods, such as the limitations attending the processing of large volumes of fluids and sensitivity to clogging. There is also a need for such devices and methods that are amenable to continuous flow processes.

### SUMMARY

To address the foregoing problems, in whole or in part, and/or other problems that may have been observed by persons skilled in the art, the present disclosure provides methods, processes, systems, apparatus, instruments, and/or devices, as described by way of example in implementations set forth below.

According to one embodiment, a microfluidic disk for concentrating particles includes: an inner edge and an outer edge coaxial with a central axis; a plurality of first distribution channels embedded in the disk, each first distribution channel comprising a curved section and communicating with a fluid inlet at the inner edge; a plurality of second distribution channels embedded in the disk and communicating with respective fluid outlets at the outer edge; and a plurality of separation channels, each separation channel extending from the curved section of one of the first distribution channels to one of the second distribution channels, each separation channel comprising a main cross-sectional area and a constriction of reduced cross-sectional area, wherein the disk defines a plurality of flow paths, each flow path running from one of the fluid inlets and through the corresponding first distribution channel, through one or more of the separation channels, through the corresponding second distribution channel and to the corresponding fluid outlet.

According to another embodiment, a centrifugal particle concentrator includes: a microfluidic disk according to any of the embodiments disclosed herein; and a device configured for spinning the disk about the central axis.

According to another embodiment, a particle analysis system includes: a microfluidic disk according to any of the embodiments disclosed herein; and an analytical instrument comprising at least one of a light source and a detector in optical alignment with the microfluidic disk.

According to another embodiment, a method for analyzing particles includes: collecting the particles in one or more separation channels of a microfluidic disk; and operating an analytical instrument to acquire data from the collected particles.

According to another embodiment, a method for concentrating particles includes: spinning a microfluidic disk about the central axis; and while spinning the microfluidic disk, flowing a sample fluid comprising the particles from the fluid inlets, through the respective flow paths, and to the respective fluid outlets, wherein the particles accumulate in the separation channels.

According to another embodiment, a method for concentrating particles includes: spinning a microfluidic disk about a central axis, the microfluidic disk comprising an inner edge and an outer edge coaxial with the central axis, a plurality of fluid inlets at the inner edge, a plurality of fluid outlets at the outer edge, a plurality of channels defining flow paths through the microfluidic disk wherein each flow path communicates with at least one fluid inlet and at least one fluid outlet, and a plurality of trap sections configured for trapping the particles wherein each trap section communicates with at least one of the flow paths; and while spinning the microfluidic disk, flowing a sample fluid comprising the particles into the fluid inlets, through the flow paths, and to the fluid outlets, wherein flowing the sample fluid while spinning the microfluidic disk directs the particles into the trap sections by inertial focusing.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is a schematic top plan view of an example of a microfluidic disk 100 according to some embodiments.

FIG. 2A is a perspective view of an example of a centrifugal particle concentrator according to some embodiments.

FIG. 2B is a cut-way side view of the centrifugal particle concentrator illustrated in FIG. 2A.

FIG. 2C is a cut-way perspective view of the centrifugal particle concentrator illustrated in FIG. 2A.

FIG. 3 is a schematic view of an example of a particle analysis system according to some embodiments.

### DETAILED DESCRIPTION

In the context of the present disclosure, the term “particle” refers generally to a solid material of interest to a researcher or user of a microfluidic disk as described herein. The particle may be a biological particle (or “bio-particle”), for example, an intact (whole) cell, a lysed or disrupted cell, a cellular component, or a biopolymer (e.g., a carbohydrate, polynucleotide, protein, etc.). The particle may also be non-biological, such as a chemical compound or an agglomerate of more than one type of chemical compound.

In the context of the present disclosure, the term “fluid” is used in a general sense to refer to any material that is flowable through a conduit. As will become evident from the ensuing disclosure, the fluid processed by a microfluidic disk as described herein is predominantly a liquid, although such a liquid may include gas pockets or bubbles. In the context of the present disclosure, a “sample fluid” generally comprises particles entrained or carried in a fluid. In typical embodiment, a sample fluid may be characterized as a suspension but in the broad aspects of the present disclosure is not limited by this characterization.

As used herein, the term “channel” refers to any type of conduit that defines a path for fluid to flow from one point to another point. In some embodiments, a channel may be a “microfluidic channel” or “microchannel.” The cross-section (or flow area) of a microchannel may have a cross-sectional dimension on the order of micrometers (e.g., up to about 1000 μm, or 1 mm) or lower (e.g., nanometers). For example, the cross-sectional dimension dimension may range from 100 nanometers to 1000 μm (1 mm). Flow rates through the microchannel may be on the order of milliliters per minute (mL/min), microliters per minute, nanoliters per minute, or lower (picoliters per minute or femtoliters per minute). The term “cross-sectional dimension dimension” refers to a type of dimension that is appropriately descriptive for the shape of the cross-section of a channel—for example, diameter in the case of a circular cross-section, major axis in the case of an elliptical cross-section, or a maximum width or height between two opposing sides in the case of a polygonal cross-section. The cross-section of the channel may have any of these shapes. Additionally, the cross-section of the channel may have an irregular shape, either deliberately or as a result of the limitations of fabrication techniques. The cross-sectional dimension dimension of an irregularly shaped cross-section may be taken to be the dimension characteristic of a regularly shaped cross-section that the irregularly shaped cross-section most closely approximates (e.g., diameter of a circle, major axis of an ellipse, width or height of a polygon, etc.).

In typical embodiments, a channel is formed in a solid body of material. The material may be of the type utilized in various fields of microfabrication such as microfluidics, microelectronics, micro-electromechanical systems (MEMS), and the like. The composition of the material may be one that is utilized in these fields as a semiconductor, electrical insulator or dielectric, vacuum seal, structural layer, or sacrificial layer. The material may thus be composed of, for example, a metalloid (e.g., silicon or germanium), a metalloid alloy (e.g., silicon-germanium), a carbide such as silicon carbide, an inorganic oxide or ceramic (e.g., silicon oxide, titanium oxide, or aluminum oxide), an inorganic nitride or oxynitride (e.g., silicon nitride or silicon oxynitride), various glasses, or various polymers such as polycarbonates (PC), polydimethylsiloxane (PDMS), etc. In some embodiments, the material forming the channel is optically transparent for a purpose such as performing an optics-based measurement, performing a sample analysis, detecting or identifying a substance flowing through the channel, enabling a user to observe flows, etc. The solid body of material may initially be provided in the form of, for example, a substrate, a layer disposed on an underlying substrate, a microfluidic chip, a die singulated from a larger wafer of the material, etc.

The channel may be formed in a solid body of material by any technique, now known or later developed in a field of fabrication, which is suitable for the material's composition and the size and aspect ratio of the channel. As non-limiting examples, the channel may be formed by an etching technique such as focused ion beam (FIB) etching, deep reactive ion etching (DRIE), soft lithography, or a micromachining technique such as mechanical drilling, laser drilling or ultrasonic milling. Depending on the length and characteristic dimension of the channel to be formed, the etching or micromachining may be done in a manner analogous to forming a vertical or three-dimensional “via” partially into or entirely through the thickness of the material (e.g., a “through-wafer” or “through-substrate” via). Alternatively, an initially open channel or trench may be formed on the surface of a substrate, which is then bonded to another substrate to complete the channel. The other substrate may present a flat surface, or may also include an initially open channel that is aligned with the open channel of the first substrate as part of the bonding process. The channel may be defined (or bounded) directly by one or more walls of a solid body of material. Alternatively, the channel may be defined by the inside surface of a tube or capillary, i.e., the tube or capillary wall is the solid body of material in which the channel is formed. In the latter case, the tube or capillary may reside in a closed bore or open bore (e.g., a trench, groove or recess) that is formed by one or more walls of another solid body of material.

Depending on its composition, the material defining the channel may be inherently chemically inert relative to the fluid flowing through the channel. Alternatively, the channel may be deactivated as part of the fabrication process, such as by applying a suitable coating or surface treatment/functionalization so as to render the channel chemically inert. Coatings and surface treatments/functionalizations for such purposes are readily appreciated by persons skilled in the art.

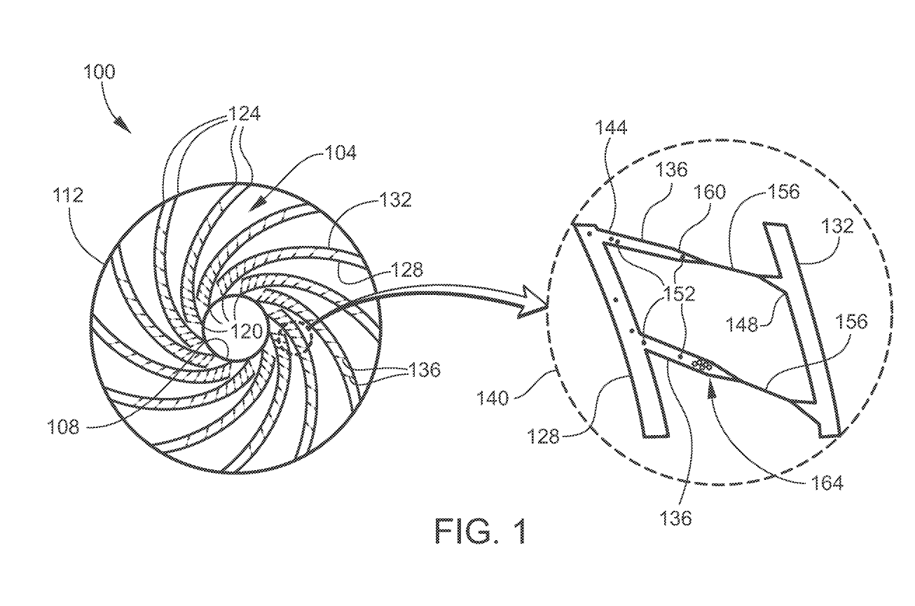

FIG. 1 is a schematic top plan view of an example of a microfluidic disk 100 according to some embodiments. The microfluidic disk 100 may generally include an annular body 104. The body 104 includes an inner edge 108 having and an outer edge 112 coaxial with a central axis of the body 104. The inner edge 108 has an inside diameter and defines a central aperture of the body 104, and the outer edge 112 has an outside diameter. The inner edge 108 and outer edge 112 define the thickness of the body 104 along the central axis. The body 104 includes a top (first) surface and a bottom (second) surface (opposing the top surface) adjoined by its thickness (i.e., by the inner edge 108 and outer edge 112). In a typical embodiment, the top surface and bottom surface are flat, i.e., orthogonal to the central axis, and are significantly larger areas that the thickness. Hence, in typical embodiment the disk 100 (body 104) may be described as being two-dimensional, planar, or plate-shaped. Generally, no limitations are placed on the physical dimensions (inside diameter, outside diameter, thickness) of the disk 100 (body 104). In some embodiments, the dimensions may be comparable to those of a compact disc (CD), while in other embodiments on or more dimensions may be appreciably larger or smaller than those of a CD.

The disk 100 includes a plurality of fluid flow paths running outward through the body 104, generally away from the central axis and along the transverse plane of the body 104 (i.e., generally orthogonal to the central axis). The flow paths are defined by a plurality of fluid inlets 120, fluid channels (or conduits, or passages, etc.), and fluid outlets 124. The fluid inlets 120 are located at the inner edge 108 and fluid outlets 124 are located at the outer edge 112. In the present context, the term “at” encompasses terms such as “near” or “proximal to.” Thus, the fluid inlets 120 may open directly at the inner edge 108 or alternatively may open at the top surface or bottom surface at a point near the inner edge 108. Likewise, the fluid outlets 124 open directly at the outer edge 112 or alternatively may open at the top surface or bottom surface at a point near the outer edge 112. The fluid inlets 120 may also be referred to as disk inlets or distribution channel inlets, and the fluid outlets 124 may also be referred to as disk outlets or distribution channel outlets.

The channels are embedded in the body 104 (i.e., extend through the bulk of the body 104). Some channels communicate with respective fluid inlets 120 and other channels communicate with respective fluid outlets 124. In some embodiments, some channels communicate with corresponding fluid inlets 120 and fluid outlets 124. The disk 100 is a microfluidic disk in that the cross-section (cross-sectional flow area) of at least some of the channels has a micro-scale dimension. At least some of the channels include curved sections. In some embodiments, as illustrated, the entire length or extent (or a substantial length or a majority of the length) of at least some of the channels are curved. As illustrated, the plurality of channels may collectively present a spiral pattern relative to the central axis. In some embodiments, the radii of curvature of the curved channels (or at least the curved sections thereof) may vary along the length of the curved channels (e.g., increase in the illustrated example). In some embodiments, as illustrated, the curved channels (or at least the curved sections thereof) are curved in the same “sense” of direction. Thus in the illustrated example, the curved channels are each convex (bulge) in the counterclockwise direction. In some embodiments, the disk 100 is spun in the same direction as the concavity of the channels, for example counterclockwise in the illustrated example.

In the illustrated embodiment, the channels include a plurality of distribution channels embedded in the disk 100 (i.e., in the body 104). The distribution channels are configured for conducting a fluid sample through the disk 100 from the distribution channel inlets 120 to the distribution channel outlets 124. The distribution channels include the curved sections. Specifically in this embodiment, the distribution channels include first distribution channels 128 embedded in the disk 100 and second distribution channels 132 embedded in the disk 100. The first distribution channels 128 communicate with respective distribution channel inlets 120, and the second distribution channels 132 communicate with respective distribution channel outlets 124. In some embodiments, as illustrated, the first distribution channels 128 also communicate with respective distribution channel outlets 124. In the illustrated embodiment, the distribution channels are arranged in pairs, each pair including at least one first distribution channel 128 and at least one second distribution channel 132.

Also in the illustrated embodiment, the channels further include a plurality of separation channels 136 embedded in the disk 100 (i.e., in the body 104). The separation channels 136 are distributed (and spaced from each other) along the length of each pair of first distribution channel 128 and second distribution channel 132. FIG. 1 includes a schematic detailed view 140 of a representative region of one of the distribution channel pairs. As shown, each separation channel 136 includes a separation channel inlet 144 communicating with the first distribution channel 128 and a separation channel outlet 148 communicating with the corresponding second distribution channel 132. Thus, each fluid flow path established by the disk 100 runs from the inner edge 108 (i.e., a distribution channel inlet 120 at or near the inner edge 108) into the corresponding first distribution channel 128, through one of the separation channels 136 and into the corresponding second distribution channel 132, and to the outer edge 112 (i.e., the corresponding distribution channel outlet 124 at or near the outer edge 112). For each distribution channel pair, the disk 100 may be considered as providing an initial flow path in the first distribution channel 128, which branches off into multiple flow paths via the separation channels 136, which then merge into a single flow path in the corresponding second distribution channel 132. The pattern of channels provided by the disk 100 may also be considered as comprising multiple ladders (e.g., curved or spiral ladders), each ladder including an inside leg (first distribution channel 128), an outside leg (second distribution channel 132), and rungs (separation channels 136).

Each separation channel 136 branches off of (extends from) the curved section of a first distribution channel 128 at an angle thereto. The cross-section (cross-sectional flow area) of each separation channel 136. In the illustrated embodiment, the separation channels 136 are radially oriented relative to the central axis, i.e., run along radii projected from the central axis along the transverse plane of the disk 100. In other embodiments, the separation channels 136 may be oriented at different angles than shown in FIG. 1. In some embodiments, the cross-section (cross-sectional flow area) of each separation channel 136 is less than the cross-section of the first distribution channel 128, and in typical embodiments is also less than the cross-section the second distribution channel 132. In some embodiments, the cross-section of the separation channels 136 (such as at the separation channel inlet 144) has at least one dimension on the scale of micrometers, and the cross-section of the first distribution channels 128 (or of both the first distribution channels 128 and the second distribution channels 132) has at least one dimension on the scale of millimeters.

Each separation channel 136 includes a trap (or trap region, or trap section) configured for trapping (accumulating, collecting) target particles 152, i.e., particles of a selected size or size range. By this configuration, target particles 152 carried in a sample fluid may be concentrated for analysis. In the illustrated embodiment, as best shown in the detailed view 140 of FIG. 1, each separation channel 136 may include a channel constriction 156 along its length (between the separation channel inlet 144 and the separation channel outlet 148). The channel constriction 156 is a section of reduced cross-section relative to the main cross-section of the separation channel 136. The cross-section of the separation channel inlet 144 may, for example, be representative of the main cross-section of the separation channel 136. The channel constriction 156 is sized such that target particles 152 cannot enter the channel constriction 156 while fluid and smaller particles can pass through to the second distribution channel 132. This configuration consequently defines a trap section just upstream of the channel constriction 156 (between the separation channel inlet 144 and channel constriction 156). The trap section may be or include a transition between the upstream section of the separation channel 136 and the channel constriction 156. For example, at the trap section the main cross-section may taper down to the reduced cross-section of the channel constriction 156.

In some embodiments, the first distribution channels 128 (or both the first distribution channels 128 and the second distribution channels 132) have at least one cross-sectional dimension on the order of micrometers (microns, μm), on the order of micrometers to millimeters (mm), or on the order of millimeters. In some embodiments, the separation channels 136 have at least one cross-sectional dimension (at the main, unreduced section and/or at the separation channel inlet 144) on the order of micrometers, on the order of micrometers to millimeters, or on the order of millimeters. As noted above, in some embodiments the cross-sections of the separation channels 136 are smaller than the cross-sections of the first distribution channels 128 (or both the first distribution channels 128 and the second distribution channels 132). In further embodiments, the cross-sections of the separation channels 136 are smaller than the cross-sections of the first distribution channels 128 (or both the first distribution channels 128 and the second distribution channels 132) by an order of magnitude. As one non-liming example, the separation channels 136 may have at least one cross-sectional dimension on the order of micrometers, while the first distribution channels 128 (or both the first distribution channels 128 and the second distribution channels 132) have at least one cross-sectional dimension on the order of millimeters (or on the order of micrometers to millimeters). In some embodiments, the channel constrictions 156 have at least one cross-sectional dimension in a range proportional to the particle being separated, typically on the order of micrometers and potentially sub-microns (e.g., nanometers, nm). Hence, in such embodiments the channel constrictions 156 may have at least one cross-sectional dimension on the order of nanometers, on the order of nanometers to micrometers, or on the order of micrometers.

In some embodiments, the trap section may include or be defined by a packing of beads 164 in the separation channel 136. The beads 164 provide a filtration matrix whereby target particles 152 become trapped in the interstitial spaces of the packing. In a typical embodiment the beads 164 are microbeads, i.e., have micro-scale dimensions. The beads 164 may have a generally monodisperse size distribution or a polydisperse size distribution (i.e., a combination of large and small beads). The beads 164 may be solid (non-porous), porous or in the form of a gel (e.g., hydrogel). The beads 164 may generally have any composition that is inert to the particle concentration process. In some embodiments, the beads 164 may be of the type utilized as a packing in chromatography columns or solid phase extraction (SPE) tubes. Examples of bead compositions include, but are not limited to, metals, metal alloys, metal oxides, silica, glasses, ceramics, and natural and synthetic polymers. In some embodiments, to enhance the concentration and/or a subsequent collection process, the beads 164 may inherently exhibit (or be functionalized to exhibit) particle retention activity such that target particles 152 may be adsorbed on or otherwise have a physical, chemical, ionic, or electrical affinity for the beads 164. In some embodiments, the beads 164 may be magnetic to facilitate retrieval or reconfiguration of the trapped particles.

In some embodiments, as illustrated, the trap section may include both a tapered region (e.g., transition 160) and a packing of beads 164, with the beads 164 being located in the tapered region.

In some embodiments the disk 100, or at least regions of the disk where the separation channels 136 are located, are optically transparent to enable observation of the fluid processing and/or optical-based in situ analysis of particles concentrated in the separation channels 136. Thus, for example, the disk 100 or regions thereof may be transparent to light of wavelengths in the ultraviolet, visible, and/or infrared ranges.

In practice, a drive device may be provided for spinning the disk 100 about its central axis at a desired rotational speed. The drive device may include a powered component such as a motor that generates torque, and a rotating linkage such as a shaft that couples the torque to the disk 100 and supports the disk 100 during spinning. The drive device may be configured for enabling a continuous flow of a sample fluid through the channels of the disk 100 while the disk 100 is being rotated. The drive device may thus include a device inlet that directs a flow of a sample fluid to the distribution channel inlets 120, and a device outlet (or receptacle) that receives the fluid flow from the distribution channel outlets 124. The device inlet and device outlet may be stationary structures in open communication with the distribution channel inlets 120 and distribution channel outlets 124. Such a configuration is unlike conventional microfluidic particle concentrating devices, which require tubing permanently connected to inlet and outlet ports and thus are capable of processing samples in batches only and in limited fluid volumes.

In operation, a sample fluid is supplied to the disk 100 by any suitable means. The flow of sample fluid to the disk 100 may be assisted by gravity, positive pressure (e.g., a pump upstream of the disk 100), or aspiration (e.g., a pump downstream of the disk 100), as appreciated by persons skilled in the art. The sample fluid contains the target particles desired to be trapped/concentrated. The sample fluid may contain a mixture of differently sized particles, i.e., target particles as well as particles larger and/or smaller than the target particles. As an example, the sample fluid may be a biological fluid containing cells (target particles) and larger aggregates. The sample fluid enters the distribution channel inlets 120 while the disk 100 is spinning and flows through the flow paths of the disk 100. The sample fluid flows through the channels under the influence of centrifugal force as a result of rotation of the disk 100. The flow rate depends on several factors but generally may be high. In some embodiments, for example, the flow rate may be on the order of milliliters per minute. As the sample fluid flows through the first distribution channels 128, target particles a given several opportunities to enter the separation channels 136 distributed along the lengths of the first distribution channels 128. The target particles are small enough yet have sufficient inertial energy to enter the separation channels 136 along with some of the fluid. The majority of the fluid continues to flow through the first distribution channels 128 without entering the separation channels 136. Other (non-target) particles and material, due to their large size and/or inertial energy, also remain in the first distribution channels 128. These other particles and material and the fluid carrying them may exit the disk 100 via distribution channel outlets 124 at which the first distribution channels 128 terminate. The target particles flowing through the separation channels 136 become trapped as described above. The fluid carrying the target particles, as well as any non-trapped smaller particles or material, flow through the channel constrictions 156, enter the second distribution channels 132, and exit the disk 100 via corresponding distribution channel outlets 124.

Generally, any type of sample fluid may be processed by the disk 100 in the manner described herein separate rare and physically discrete particles from large volumes of fluids. Examples include, but are not limited to, sea water (e.g., containing rare microbial cells) and blood (e.g., containing cancer cells).

The configuration of the disk 100 (e.g., channel dimensions, curvature, and cross-sectional geometry, etc.) and its operating conditions (e.g., angular speed, flow rate, etc.) may be tailored to achieve a desired size selection, i.e., the size or range of sizes of particles capable of being concentrated in the separation channels 136. In typical embodiments, the parameters are selected such that the flow of sample fluid through the disk 100 is laminar. The Reynolds number Re in the channels may be quite low, for example less than 200 or less than 100.

In some embodiments, the configuration of the disk 100 and its operating conditions may be specifically tailored to control inertial focusing of particles in the sample fluid in a way that enhances the selective diversion of the desired target particles into the separation channels 136. Particles of a target size may be become ordered into one or more distinct streamlines at specific locations relative to the walls of the curved first distribution channels 128. This may be achieved by allowing the development of a drag force (Dean drag) on the particles that results in a secondary flow (Dean flow), whereby particles migrate laterally across the channel cross-section into an equilibrium position observed as a focused streamline of the particles. The magnitude of this Dean flow has been characterized by the non-dimensional Dean number De, which is related to the channel Reynolds number Re_{C} as follows: De=Re_{C} (Dₕ/2R)^{0.5}, where R is the average radius of curvature of the channel, Re_{C} is the channel Reynolds number (Re_{C}=3ρU_{Avg}Dh/2μ), ρ is the fluid density, U_{Avg} is the average downstream fluid velocity, μ is the dynamic viscosity of the fluid, and Dₕ is the hydraulic diameter (Dₕ=2hw/(h+w)), and h and w are the height and width of the channel, respectively. See, e.g., Martel, J. M. & Toner, Inertial focusing dynamics in spiral microchannels, Phys. Fluids 24, 032001 (2012), the content of which are incorporated by reference herein in its entirety.

In some embodiments, the disk 100 may include microvalves configured for non-contact operation such that the microvalves are controllable while the disk 100 is spinning. Such microvalves may be desirable to add another dimension to the control of fluid flow in the disk 100 for various purposes such as, for example, redirecting flow in a channel or from one channel to another, segregating fluids and/or particles that that have been separated from the bulk stream, diverting fluids and/or particles to regions where they may interact with a reagent or where they may be collected, etc. In some embodiments, the microvalves may be constructed from a photo-responsive polymer or other photo-responsive material. As one example, the photo-responsive polymer may be a hydrogel such as spirobenzopyran-functionalized poly(N-isopropylacrylamide) (pSPNIPAAm). In this case, the disk 100 may comprise a hydrogel layer sandwiched between an upper layer and a lower layer, with either the upper layer or lower layer containing the channels. The microvalves may be defined by positions along the lengths of one or more channels, or at the junction of two channels (e.g., at the junction between a segregation channel 136 and a first distribution channel 128 and/or second distribution channel 132) that terminate at vertical ports (vias or through-holes) that lead down (or up) to the hydrogel layer. Irradiation of the hydrogel layer by blue or ultraviolet (UV) light (using a coherent electromagnetic source such as a laser) at the location of the microvalve (i.e., irradiation of a portion of the hydrogel adjacent to an inlet port and an outlet port of the channel or junction) causes localized shrinking of the hydrogel. This irradiation results in the formation of a fluid path from the inlet port, through the space previously occupied by the hydrogel (under or above the layer containing the channels), and to the outlet port. See, e.g., Sugiura et al., On-demand microfluidic control by micropatterned light irradiation of a photoresponsive hydrogel sheet, Lab Chip 9, 196-198 (2009), the content of which are incorporated by reference herein in its entirety.

In some embodiments, the microvalves may be constructed from a thermally-responsive polymer or other thermally-responsive material. The thermally-responsive material may be, for example, an appropriate hydrogel, paraffin, or the like. In this case, infrared (IR) radiation may be utilized to induce volumetric change in the hydrogel or phase transition (e.g., melting) of the paraffin to “open” the microvalve. See, e.g., the above-cited reference by Sugiura et al.

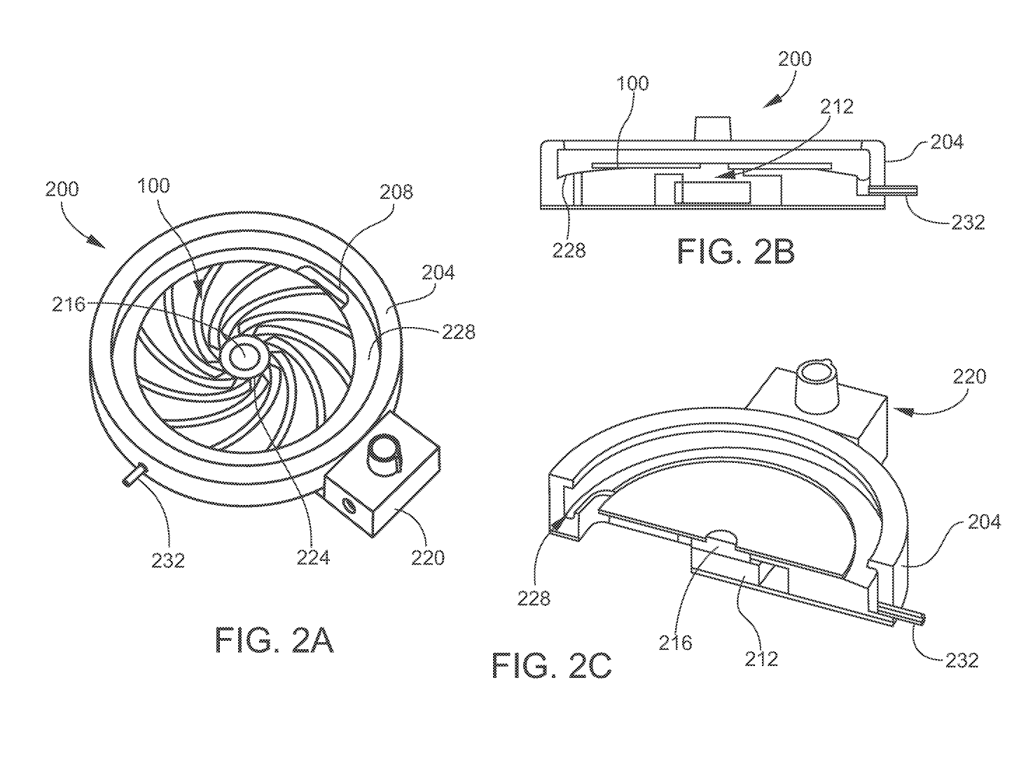

FIG. 2A is a perspective view of an example of a centrifugal particle concentrator (or concentrating or trapping device) 200 according to some embodiments. A microfluidic disk such as the disk 100 described above may be removably loaded into the centrifugal particle concentrator 200. FIG. 2B is a cut-way side view of the centrifugal particle concentrator 200, which has been cut-away along the diameter of the disk 100. FIG. 2C is a cut-way perspective view of the centrifugal particle concentrator 200. The centrifugal particle concentrator 200 may utilized to spin the disk 100 as part of implementing a particle concentrating process as disclosed herein.

The centrifugal particle concentrator 200 may include a frame or housing 204 configured for receiving and containing the disk 100. The top and/or bottom of the housing 204 may be open (or include a transparent lid) to enable the transmission of light rays. In the illustrated embodiment, the top is open and the bottom includes a window 208 for this purpose. Light rays may be transmitted in conjunction with performing an in situ analysis of target particles captured by the disk 100. For example, the light rays transmitted may be a focused optical excitation beam (e.g., from a laser) directed to the target particles in conjunction with an optics-based measurement (e.g., fluorescence, absorption, transmission, scattering, etc.), and/or measurement light emitted from the target particles (e.g., in response to excitation, reagent-induced luminescence, etc.). Alternatively or additionally, an optical beam may be utilized for tracking or indexing the positions of the target particles in the trap sections of the separation channels, as appreciated by persons skilled in the art.

The centrifugal particle concentrator 200 may include a drive device configured for spinning the disk 100 about its central axis at a desired rotational speed. The drive device may include a motor 212 and a shaft 216. The shaft may be coupled to the disk 100 by any means suitable for efficiently transmitting torque to the disk 100. For example, the shaft 216 may include or be coupled to a rotatable platform that supports the disk 100. The platform or other component of the centrifugal particle concentrator 200 may be configured for enabling the disk 100 to be securely loaded in or on the housing 204 and removed thereafter. In some embodiments, the motor 212, shaft 216, and components engaging the disk 100 may be similar to components provided by CD readers. The centrifugal particle concentrator 200 may also include a drive controller 220 coupled to the motor 212 for controlling the angular speed of the disk 100. As appreciated by persons skilled in the art, the controller 220 may include one or more buttons and/or knobs for enabling user input (e.g., power on/off, speed adjustment, etc.), and may generally serve as an enclosure for the local electronics of the centrifugal particle concentrator 200, receiving a power cable, etc.

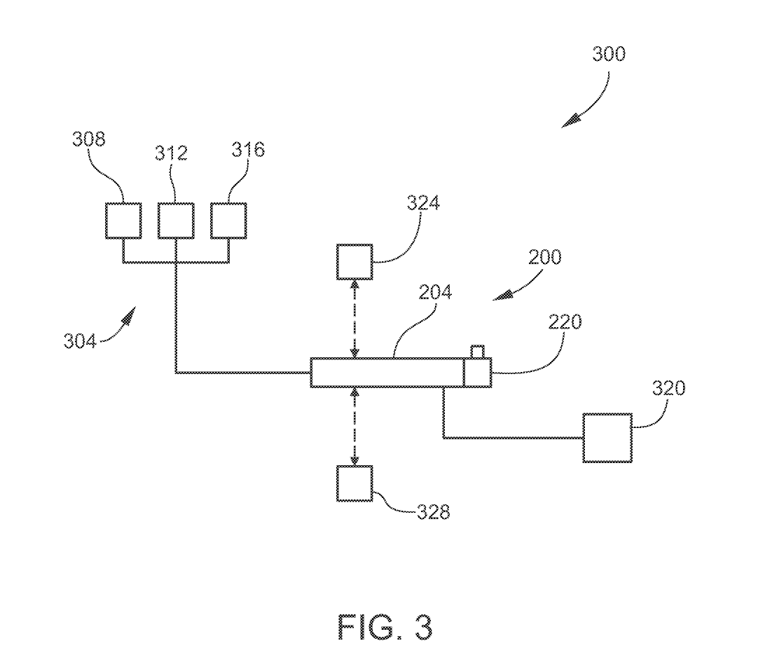

The centrifugal particle concentrator 200 may further include a device inlet for introducing sample fluid to the fluid inlets of the disk 100 (e.g., distribution channel inlets 120, FIG. 1) and a device outlet for receiving the fluid flow from the fluid outlets of the disk 100 (e.g., distribution channel outlets 124, FIG. 1). In the illustrated example, the device inlet and device outlet are provided as an annular inlet plenum 224 surrounding the shaft 216 and an annular outlet plenum 228 surrounding the disk 100, respectively. The inlet plenum 224 may be open at the top side of the centrifugal particle concentrator 200 to receive a sample fluid from a conduit or dispenser and/or may be coupled to upstream fluid circuitry, such as a fluid supply system as described below in conjunction with FIG. 3. The outlet plenum 228 may communicate with a drain or outlet 232, which may in turn be coupled to downstream fluid circuitry, collection receptacle, fluidic device, etc.

As shown in FIG. 3, the centrifugal particle concentrator 200 (or a system associated therewith) may include a fluid supply system 304 configured for selectively supplying one or more types of fluids to the channels of the disk 100. The fluid supply system 304 may include one or more sources (e.g., reservoirs) of fluid, for example a sample fluid source 308, a reagent fluid source 312, a rinse fluid source 316, etc. As appreciated by persons skilled in the art, the reagent fluid may include any reagent, labelling agent, etc. useful in conjunction with implementing a particular type of analysis. The rinse fluid may be any type of solvent or other fluid useful for rinsing/washing the channels of the disk 100 between sample runs, or for buffering or diluting the sample fluid, etc. The fluid supply system 304 may schematically represent any combination of fluidic components provided for conducting a selected fluid to the disk 100, such as pumps, valves, conduits, etc. The fluid supply system 304 may be coupled to a component of the centrifugal particle concentrator 200 so as to communicate with its device inlet (e.g., inlet plenum 224, FIG. 2), or may terminate at a fluid outlet (e.g., the tip of a conduit, dispenser, etc.) placed proximal to and in open communication with the device inlet. FIG. 3 schematically illustrates three fluid sources integrated with the fluid supply system 304. It will be understood, however, that one or more fluid sources may be separate from the fluid supply system 304. For example, a separate dispenser may be utilized to add a small amount of reagent to the device inlet while the fluid supply system 304 is being operated to maintain a flow of sample fluid to the device inlet. FIG. 3 also illustrates a collection unit 320, which may be coupled to the centrifugal particle concentrator 200 (e.g., the outlet plenum 228 or outlet 232, FIG. 2) to receive filtrate for disposal, analysis, or other purpose.

FIG. 3 is also a schematic view of an example of a particle analysis system 300 according to some embodiments. The particle analysis system 300 may generally include a disk holder and an analytical instrument. The disk holder may be any structure configured for holding a microfluidic disk such as the disk 100 described herein. The analytical instrument may be any analytical instrument capable of interacting with target particles captured by the disk 100 as part of a process for acquiring analytical data from the target particles. In some embodiments, the centrifugal particle concentrator 200 may serve as the disk holder as illustrated in FIG. 3. In this case, the analytical instrument may be positioned in an operative relation to the centrifugal particle concentrator 200 while the centrifugal particle concentrator 200 is operated to spin the disk 100 and concentrate the target particles. Depending on the type of analytical instrument, the analytical instrument may be operated to acquire data while particles are being concentrated or after the concentrating process has ceased. In other embodiments, the analytical instrument may be remotely or separately positioned relative to the centrifugal particle concentrator 200. In this case, the analytical instrument may be configured to receive the centrifugal particle concentrator 200. For example, after the centrifugal particle concentrator 200 has been operated to concentrate the particles, the centrifugal particle concentrator 200 may be transported to the analytical instrument and operatively positioned so as to enable data acquisition. Alternatively, the analytical instrument may include a separate disk holder, in which case, the disk 100 may be removed from the centrifugal particle concentrator 200 and placed in the disk holder.

In FIG. 3, the analytical instrument is schematically depicted as including analytical components 324 and 328 positioned above and/or below the disk 100 held in the centrifugal particle concentrator 200 (or other disk holder). In some embodiments, the analytical instrument may be an optics-based instrument such as, for example, a spectroscopy apparatus, a cytometer, a microscope, an imaging device, etc. Thus, the type of data acquired may relate to, for example, optics-assisted visual observation, image analysis, particle counting, or measurements based on absorbance, transmittance, scattering, fluorescence, phosphorescence, luminescence, etc. Thus, in some embodiments the analytical component 324 may represent a light source and/or a top reading light detector, and the analytical component 328 may represent a light source and/or a bottom reading light detector. The light source may be, for example, a light emitting diode (LED), a laser, a laser diode (LD), an arc lamp, a flash lamp, or a broadband light source. The light detector may be, for example, a photodiode, photomultiplier tube, image sensor, pixel array, camera, etc.

In other embodiments, the particles concentrated in the disk 100 may be removed from the disk 100 (by, for example, back flushing), collected, and subjected to other types of analysis, such as various types spectrometry, spectroscopy, electrophysiology and/or cytometry (in the case of biological cells), etc.

Accordingly, the subject matter disclosed herein encompasses methods for analyzing particles. As an example, the method may include collecting (concentrating) particles in the disk 100, and operating an analytical instrument to acquire data from the collected particles. In some embodiments, the disk 100 is positioned at the analytical instrument. The analytical instrument may be operated while the particles are being collected (i.e., while the disk 100 is spinning) or after the collection process has been completed. In other embodiments, the particles are removed from the disk 100 before operating the analytical instrument. In some embodiments, depending on the type of analysis being implemented, the particles are reacted with a reagent. In some embodiments, the reagent is introduced into the flow paths of the disk 100 and flowed into contact with the particles trapped by the disk 100.

### EXEMPLARY EMBODIMENTS

Exemplary embodiments provided in accordance with the presently disclosed subject matter include, but are not limited to, the following:

1. A microfluidic disk for concentrating particles, comprising: an inner edge and an outer edge coaxial with a central axis; a plurality of first distribution channels embedded in the disk, each first distribution channel comprising a curved section and communicating with a fluid inlet at the inner edge; a plurality of second distribution channels embedded in the disk and communicating with respective fluid outlets at the outer edge; and a plurality of separation channels, each separation channel extending from the curved section of one of the first distribution channels to one of the second distribution channels, each separation channel comprising a main cross-sectional area and a constriction of reduced cross-sectional area, wherein the disk defines a plurality of flow paths, each flow path running from one of the fluid inlets and through the corresponding first distribution channel, through one or more of the separation channels, through the corresponding second distribution channel and to the corresponding fluid outlet.

2. The microfluidic disk of embodiment 1, wherein at least regions of the microfluidic disk in which the separation channels are located are optically transparent.

3. The microfluidic disk of embodiment 1 or 2, wherein each first distribution channel has a total length, and the curved section extends for all or a substantial portion of the total length.

4. The microfluidic disk of any of the preceding embodiments, wherein one or more of the curved sections have a varying radius of curvature.

5. The microfluidic disk of any of the preceding embodiments, wherein each second distribution channel comprises a curved section.

6. The microfluidic disk of any of the preceding embodiments, wherein the first distribution channels and the second distribution channels are arranged in a spiral pattern relative to the central axis.

7. The microfluidic disk of any of the preceding embodiments, wherein one or more of the first distribution channels communicate with respective fluid outlets.

8. The microfluidic disk of any of the preceding embodiments, wherein the main cross-sectional area is smaller than the cross-sectional area of the first distribution channels.

9. The microfluidic disk of any of the preceding embodiments, wherein each separation channel comprises a trap section between the corresponding first distribution channel and the constriction.

10. The microfluidic disk of embodiment 9, wherein the trap section has a cross-sectional area that tapers down to the reduced cross-sectional area of the constriction.

11. The microfluidic disk of embodiment 9 or 10, comprising a packing of beads positioned in the trap section.

12. The microfluidic disk of embodiment 11, wherein the beads are magnetic.

13. The microfluidic disk of any of the preceding embodiments, wherein each separation channel is oriented in a radial direction relative to the central axis.

14. The microfluidic disk of any of the preceding embodiments, wherein the first distribution channels, the second distribution channels, and the separation channels have polygonal or rounded cross-sections.

15. The microfluidic disk of any of the preceding embodiments, wherein each first distribution channel has a cross-sectional dimension on the order of micrometers, on the order of micrometers to millimeters, or on the order of millimeters.

16. The microfluidic disk of any of the preceding embodiments, wherein each separation channel has a cross-sectional dimension on the order of micrometers, on the order of micrometers to millimeters, or on the order of millimeters.

17. The microfluidic disk of any of the preceding embodiments, wherein each first distribution channel has a cross-sectional dimension on the order of millimeters, and each separation channel has a cross-sectional dimension on the order of micrometers.

18. The microfluidic disk of any of the preceding embodiments, wherein the reduced cross-sectional area has a cross-sectional dimension on the order of nanometers, on the order of nanometers to micrometers, on the order of micrometers.

19. A centrifugal particle concentrator, comprising: the microfluidic disk of embodiment 1; and a device configured for spinning the disk about the central axis.

20. The centrifugal particle concentrator of embodiment 19, comprising a plenum positioned for receiving fluid from at least the second distribution channels.

21. The centrifugal particle concentrator of embodiment 19 or 20, comprising a plenum positioned for transferring fluid into the first distribution channels.

22. The centrifugal particle concentrator of any of embodiments 19 to 21, wherein the device comprises a controller configured for adjusting an angular speed of the microfluidic disk.

23. The centrifugal particle concentrator of any of embodiments 19 to 22, comprising a fluid supply system communicating with the inner edge.

24. The centrifugal particle concentrator of embodiment 23, wherein the fluid supply system is configured for selectively flowing a fluid selected from the group consisting of: a sample fluid comprising the particles; a reagent fluid; and a rinse fluid.

25. The centrifugal particle concentrator of any of embodiments 19 to 24, comprising a housing in which the microfluidic disk is disposed, wherein the microfluidic disk comprises a first outer surface and a second outer surface orthogonal to the central axis, and the housing is configured for enabling light to be transmitted to at least one of the first outer surface and the second outer surface.

26. A particle analysis system, comprising: the microfluidic disk of embodiment 1; and an analytical instrument comprising at least one of a light source and a detector in optical alignment with the microfluidic disk.

27. The particle analysis system of embodiment 26, comprising a disk holder supporting the microfluidic disk.

28. The particle analysis system of embodiment 27, wherein the disk holder comprises a device configured for spinning the disk about the central axis.

29. The particle analysis system of embodiment 27 or 28, wherein the disk holder comprises a plenum positioned for receiving fluid from at least the second distribution channels, a plenum positioned for transferring fluid into the first distribution channels, or both of the foregoing.

30. The particle analysis system of any of embodiments 26 to 29, wherein the analytical instrument is selected from the group consisting of a spectrometer, a spectroscopy apparatus, a cytometer, a microscope, and an imaging apparatus.

31. A method for analyzing particles, the method comprising: collecting the particles in one or more separation channels of the microfluidic disk of embodiment 1; and operating an analytical instrument to acquire data from the collected particles.

32. The method of embodiment 31, comprising removing the collected particles from the microfluidic disk before operating the analytical instrument.

33. The method of embodiment 31, comprising positioning the microfluidic disk at the analytical instrument before operating the analytical instrument.

34. The method of any of embodiments 31 to 33, comprising reacting the collected particles with a reagent.

35. The method of any of embodiments 31 to 34, wherein the analytical instrument is selected from the group consisting of a spectrometer, a spectroscopy apparatus, a cytometer, a microscope, and an imaging apparatus.

36. A method for concentrating particles, the method comprising: spinning the microfluidic disk of embodiment 1 about the central axis; and while spinning the microfluidic disk, flowing a sample fluid comprising the particles from the fluid inlets, through the respective flow paths, and to the respective fluid outlets, wherein the particles accumulate in the separation channels.

37. A method for concentrating particles, the method comprising: spinning a microfluidic disk about a central axis, the microfluidic disk comprising an inner edge and an outer edge coaxial with the central axis, a plurality of fluid inlets at the inner edge, a plurality of fluid outlets at the outer edge, a plurality of channels defining flow paths through the microfluidic disk wherein each flow path communicates with at least one fluid inlet and at least one fluid outlet, and a plurality of trap sections configured for trapping the particles wherein each trap section communicates with at least one of the flow paths; and while spinning the microfluidic disk, flowing a sample fluid comprising the particles into the fluid inlets, through the flow paths, and to the fluid outlets, wherein flowing the sample fluid while spinning the microfluidic disk directs the particles into the trap sections by inertial focusing.

38. The method of embodiment 37, wherein the particles directed into the trap sections are target particles of a target size range, and further comprising discharging other particles outside of the target size range from the fluid outlets while spinning the microfluidic disk.

39. The method of any of the preceding embodiments, wherein the particles are selected from the group consisting of non-biological particles, bio-particles, whole cells, lysed cells, and cellular components.

For purposes of the present disclosure, it will be understood that when a layer (or film, region, substrate, component, device, or the like) is referred to as being “on” or “over” another layer, that layer may be directly or actually on (or over) the other layer or, alternatively, intervening layers (e.g., buffer layers, transition layers, interlayers, sacrificial layers, etch-stop layers, masks, electrodes, interconnects, contacts, or the like) may also be present. A layer that is “directly on” another layer means that no intervening layer is present, unless otherwise indicated. It will also be understood that when a layer is referred to as being “on” (or “over”) another layer, that layer may cover the entire surface of the other layer or only a portion of the other layer. It will be further understood that terms such as “formed on” or “disposed on” are not intended to introduce any limitations relating to particular methods of material transport, deposition, fabrication, surface treatment, or physical, chemical, or ionic bonding or interaction. The term “interposed” is interpreted in a similar manner.

In general, terms such as “communicate” and “in . . . communication with” and “coupled” (for example, a first component “communicates with” or “is in communication with” a second component, or a first component “is coupled to” a second component) are used herein to indicate a structural, functional, mechanical, electrical, signal, optical, magnetic, electromagnetic, ionic or fluidic relationship between two or more components or elements. As such, the fact that one component is said to communicate with or be coupled to a second component is not intended to exclude the possibility that additional components may be present between, and/or operatively associated or engaged with, the first and second components.

It will be understood that various aspects or details of the invention may be changed without departing from the scope of the invention. Furthermore, the foregoing description is for the purpose of illustration only, and not for the purpose of limitation—the invention being defined by the claims.

What is claimed is:

1. A microfluidic disk for concentrating particles, comprising:
an inner edge and an outer edge coaxial with a central axis;
a plurality of first distribution channels embedded in the disk, each first distribution channel comprising a curved section and communicating with a fluid inlet at the inner edge;
a plurality of second distribution channels embedded in the disk and communicating with respective fluid outlets at the outer edge; and
a plurality of separation channels, each separation channel extending from the curved section of one of the first distribution channels to one of the second distribution channels, each separation channel comprising a main cross-sectional area and a constriction of reduced cross-sectional area,
wherein the disk defines a plurality of flow paths, each flow path running from one of the fluid inlets and through the corresponding first distribution channel, through one or more of the separation channels, through the corresponding second distribution channel and to the corresponding fluid outlet.

2. The microfluidic disk of claim 1, wherein at least regions of the microfluidic disk in which the separation channels are located are optically transparent.

3. The microfluidic disk of claim 1, wherein each first distribution channel has a total length, and the curved section extends for all or a substantial portion of the total length.

4. The microfluidic disk of claim 1, wherein the first distribution channels and the second distribution channels are arranged in a spiral pattern relative to the central axis.

5. The microfluidic disk of claim 1, wherein one or more of the first distribution channels communicate with respective fluid outlets.

6. The microfluidic disk of claim 1, wherein the main cross-sectional area is smaller than the cross-sectional area of the first distribution channels.

7. The microfluidic disk of claim 1, wherein each separation channel comprises a trap section selected from the group consisting of:
a trap section between the corresponding first distribution channel and the constriction;
a trap section between the corresponding first distribution channel and the constriction, wherein the trap section has a cross-sectional area that tapers down to the reduced cross-sectional area of the constriction;
a trap section between the corresponding first distribution channel and the constriction, comprising a packing of beads positioned in the trap section; and
a combination of two or more of the foregoing.

8. The microfluidic disk of claim 1, wherein each separation channel is oriented in a radial direction relative to the central axis.

9. The microfluidic disk of claim 1, comprising a dimension selected from the group consisting of:
each first distribution channel has a cross-sectional dimension on the order of millimeters;
each separation channel has a cross-sectional dimension on the order of micrometers;
each reduced cross-sectional area has a cross-sectional dimension on the order of micrometers or nanometers; and
a combination of two or more of the foregoing.

10. A centrifugal particle concentrator, comprising:
the microfluidic disk of claim 1; and
a device configured for spinning the disk about the central axis.

11. The centrifugal particle concentrator of claim 10, comprising a plenum selected from the group consisting of:
a plenum positioned for receiving fluid from at least the second distribution channels;
a plenum positioned for transferring fluid into the first distribution channels; and
both of the foregoing.

12. A particle analysis system, comprising:
the microfluidic disk of claim 1; and
an analytical instrument comprising at least one of a light source and a detector in optical alignment with the microfluidic disk.

13. The particle analysis system of claim 12, comprising a disk holder supporting the microfluidic disk.

14. The particle analysis system of claim 13, wherein the disk holder comprises a device configured for spinning the disk about the central axis.

15. A method for analyzing particles, the method comprising:
collecting the particles in one or more separation channels of the microfluidic disk of claim 1; and
operating an analytical instrument to acquire data from the collected particles.

16. The method of claim 15, comprising removing the collected particles from the microfluidic disk before operating the analytical instrument.

17. The method of claim 15, comprising positioning the microfluidic disk at the analytical instrument before operating the analytical instrument.

18. A method for concentrating particles, the method comprising:
spinning the microfluidic disk of claim 1 about the central axis; and
while spinning the microfluidic disk, flowing a sample fluid comprising the particles from the fluid inlets, through the respective flow paths, and to the respective fluid outlets,
wherein the particles accumulate in the separation channels.

19. A method for concentrating particles, the method comprising:
spinning a microfluidic disk about a central axis, the microfluidic disk comprising an inner edge and an outer edge coaxial with the central axis, a plurality of fluid inlets at the inner edge, a plurality of fluid outlets at the outer edge, a plurality of channels defining flow paths through the microfluidic disk wherein each flow path communicates with at least one fluid inlet and at least one fluid outlet, and a plurality of trap sections configured for trapping the particles wherein each trap section communicates with at least one of the flow paths; and
while spinning the microfluidic disk, flowing a sample fluid comprising the particles into the fluid inlets, through the flow paths, and to the fluid outlets,
wherein flowing the sample fluid while spinning the microfluidic disk directs the particles into the trap sections by inertial focusing.

20. The method of claim 19, wherein the particles directed into the trap sections are target particles of a target size range, and further comprising discharging other particles outside of the target size range from the fluid outlets while spinning the microfluidic disk.
